(19) United States
(12) Patent Application Publication
(10) Pub. No.: US 2024/0101040 A1
(43) Pub. Date: Mar. 28, 2024

(54) MULTI-VERSATILE RACK FOR CARRYING AND TRANSPORTING SPORTS EQUIPMENT ON A VEHICLE

(71) Applicant: Liza Ibanez, San Francisco, CA (US)

(72) Inventor: Liza Ibanez, San Francisco, CA (US)

(21) Appl. No.: 17/954,710

(22) Filed: Sep. 28, 2022

(51) Int. Cl. B60R 9/08; B60R 9/048

(52) U.S. Cl. CPC B60R 9/08; B60R 9/048

(57) ABSTRACT

A multi-versatile rack for carrying and transporting sports equipment on a vehicle is disclosed. The multi-versatile rack may also be used as a board stacker, a sling, a board sleeve, a changing mat, a beach mat, a seat cover and a tote bag, a slide mat, and a cockpit cover. The multi-versatile rack may be provided with extra padded straps for additional padding or length. The additional straps or tie down straps are used for securely holding the sports equipment, for example, sleds, skis, canoes, kayaks, and surfboards, etc. on the vehicle roof during transporting the sports equipment. The additional straps or tie down straps may also be used for safely stacking at least two or more surfboards. In one embodiment, the additional straps or tie down straps secures around the hood of the vehicle to keep the multi-versatile rack more secure.

### BACKGROUND OF THE INVENTION

### A. Technical Field

The present invention generally relates to a multi-versatile rack for a vehicle. More specifically, the present invention relates to a multi-versatile rack configured to be used for safely transporting objects and sports equipment such as, but not limited to, kayaks, surfboard, and snowboards, etc. and other equipment by securing to the vehicle roof. The multi-versatile rack may also be used as a board stacker, a sling, a board sleeve, a changing mat, a beach mat, a seat cover and a tote bag, a slide mat, and a cockpit cover.

### B. Description of Related Art

People frequently need to carry sports equipment and objects on the exterior, rather than the interior, of their vehicles. This may be because the sports equipment such as sleds, skis, canoes, kayaks, and surfboards, etc. are too long and uncomfortable to place inside of the vehicle. Accordingly, racks and other devices have been designed over the years which are intended to be fastened to the vehicle roof for the purpose of carrying and transporting such objects. Racks are commonly attached to the roofs of vehicles to carry such sports equipment as sleds, canoes, kayaks, and surfboards.

However, the existing racks used for transporting sports equipment may scratch the paint finish or otherwise damage the vehicle roof to which they are attached during turns, accelerations, decelerations, and other sudden movements of the vehicle. Further, the existing racks may not be able to safely secure the sports equipment while transporting the sports equipment due to which the sports equipment may get damage. Further, the existing racks are heavy and difficult to install or mounted on the vehicle roof.

In light of the above-mentioned problems, it would be highly desirable to provide a multi-versatile rack configured to be used for safely transporting objects and sports equipment such as, but not limited to, kayaks and snowboards, etc. and other equipment by securing to the vehicle roof. There is also a need to provide a multi-versatile rack that may also be used as a board stacker, a sling, a board sleeve, a changing mat, a beach mat, a seat cover and a tote bag, a slide mat, and a cockpit cover. There is also a need to provide a multi-versatile rack to safely secure the sports equipment and other objects while carrying and transporting and that protects the sports equipment and/or other objects from damage during carrying and transporting. Further, there is also a need to provide a multi-versatile rack that is lighter, more portable, safe, simple to install or mount on a vehicle roof, and easier to carry like a tote bag than the racks found in the prior art. The multi-versatile rack has even greater and more versatile storage capabilities.

### SUMMARY OF THE INVENTION

The present invention generally discloses a multi-versatile rack for a vehicle. More specifically, the present invention relates to a multi-versatile rack configured to be used for safely transporting objects and sports equipment such as, but not limited to, kayaks, surfboard, and snowboards, etc. and other equipment by securing to the vehicle roof. The multi-versatile rack may also be used as a board stacker, a sling, a board sleeve, a changing mat, a beach mat, a seat cover and a tote bag, a slide mat, and a cockpit cover.

In one embodiment, multi-versatile rack may be used for carrying and transporting sports equipment, for example, a kayak on a vehicle in one embodiment of the present invention is disclosed. The multi-versatile rack is an innovative and intelligent product that has been designed to securely carry and transport sports equipment. In one embodiment, the multi-versatile rack comprises a flat body portion and one or more straps. The one or more straps may be at least three pairs of straps. The straps are extending along the length of the flat body portion on its side edges. The multi-versatile rack has one or more fasteners at the ends of the straps. In one embodiment, each pair of straps includes a fastener at their distal ends configured to lock with each other. In one embodiment, the fasteners may be buckles and Velcro® or hook and loop (H&L) fasteners. In one embodiment, the multi-versatile rack further comprises a pair of handles. The handles are sewed to the outer periphery of the flat body portion. The handle allows the user to simply carry the sports equipment, for example, a kayak. In one embodiment, the multi-versatile rack further comprises a built in compartment with a zipper to convert as a tote bag.

In one embodiment, the multi-versatile rack is configured to securely carry and transport sports equipment, for example, a kayak on a vehicle roof. In one embodiment, the multi-versatile rack comprises one or more straps. The multi-versatile rack is secured to the kayak by extending the straps over the kayak and joining by using one or more fasteners, for example, buckles and Velcro® or hook and loop (H&L) fasteners. In one embodiment, the multi-versatile rack may be used for carrying and transporting other objects and sports equipment by securing to the vehicle roof.

In one embodiment, the multi-versatile rack may be a multi-versatile car rack. In one embodiment, the multi-versatile rack may protect more of the vehicle roof and equipment, or anything that transport on the vehicle roof. In one embodiment, the multi-versatile rack may also be used as a board stacker, a sling, a board sleeve, a changing mat, a beach mat, a seat cover and a tote bag, a slide mat, and a cockpit cover. In addition, the user may use two features at the same time and has a built in compartment with a zipper to convert as a tote bag.

In one embodiment, the multi-versatile rack may be used as a sliding mat for the kayak. In one embodiment, the multi-versatile rack allows the kayak to slide easily over its surface. The multi-versatile rack may also be used for sliding onto the vehicle from the rear side, without scratching the paint finish or otherwise damage the vehicle roof.

In one embodiment, the multi-versatile rack is further configured to securely carry and transport the surfboard on the vehicle roof. The multi-versatile rack is secured to the surfboard by extending the straps over the surfboard and joining by using one or more fasteners, for example, buckles and Velcro® or hook and loop (H&L) fasteners. In one embodiment, the multi-versatile rack may be provided with additional straps, which are configured to securely hold the surfboard against the roof of the vehicle when the additional straps are tightened. In one embodiment, the additional straps may be, but not limited to, tie down straps.

In one embodiment, the multi-versatile rack is further configured to use as a sling for simply carrying the kayak by the user. In one embodiment, the multi-versatile rack may be provided with an additional strap. In one embodiment, the additional strap is adjustably secured or affixed to at least any one side portion of the multi-versatile rack via fasteners, for example, buckles or hooks, etc. The user could wear the strap over the shoulder, thereby enabling the user to simply carry the kayak using the multi-versatile rack as a sling.

In one embodiment, the additional strap may also include at least one length adjusting element so that the length of the strap is adjusted by the users. In one embodiment, the additional strap may be an elongated adjustable strap. In some embodiments, the additional strap may be, but not limited to, a shoulder strap. In one embodiment, the kayak may be, but not limited to, w-kayak. In one embodiment, the multi-versatile rack is further configured to use as a sling for simply carrying the surfboard. The user could wear the strap over the shoulder, thereby enabling the user to simply carry the surfboard using the multi-versatile rack as a sling.

In one embodiment, the multi-versatile rack is further configured to be used as a cockpit cover for covering the cockpit opening or seat opening of the kayak. The multi-versatile rack is properly secured to the perimeter of the cockpit opening or seat opening using the straps. In one embodiment, the multi-versatile rack is fully covered the cockpit opening or seat opening of the kayak to protect while in storage or when being transported.

In one embodiment, the multi-versatile rack is configured to allow the user to stack at least one or more surfboards for transporting. In one embodiment, the multi-versatile rack is secured to the surfboard using the straps. In one embodiment, the straps are secured or joined using one or more fasteners, for example, buckles and Velcro® or hook and loop (H&L) fasteners.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 exemplarily illustrates a front perspective view of a multi-versatile rack, according to an one embodiment of the present invention.

FIG. 2 exemplarily illustrates a rear perspective view of the multi-versatile rack, according to one embodiment of the present invention.

FIG. 3 exemplarily illustrates an enlarged view of the multi-versatile rack, according to one embodiment of the present invention.

FIG. 4 exemplarily illustrates a perspective view of a multi-versatile rack may be used for carrying and transporting sports equipment, for example, a kayak on a vehicle, according to an embodiment of the present invention.

FIG. 5 exemplarily illustrates a perspective view of the multi-versatile rack may be used as a slide mat for the kayak, according to another embodiment of the present invention.

FIG. 6 exemplarily illustrates a perspective view of the multi-versatile rack may be used for carrying and transporting a surfboard on the vehicle, according to one embodiment of the present invention.

FIG. 7 exemplarily illustrates a perspective view of the multi-versatile rack may be used as a sling for carrying the kayak by a user, according to one embodiment of the present invention.

FIG. 8 exemplarily illustrates a perspective view of the multi-versatile rack may be used as a sling for carrying the surfboard by the user, according to one embodiment of the present invention.

FIG. 9 exemplarily illustrates a perspective view of the multi-versatile rack may be used as a cockpit cover for the kayak, according to one embodiment of the present invention.

FIG. 10 exemplarily illustrates a perspective view of the multi-versatile rack may be used for stacking at least one surfboard by the user, according to one embodiment of the present invention.

FIGS. 11-12 exemplarily illustrate the multi-versatile rack may be used for stacking at least two or more surfboards by the user, according to one embodiment of the present invention.

FIG. 13 exemplarily illustrates a perspective view of the multi-versatile rack rolled up via a simple folding arrangement, according to one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

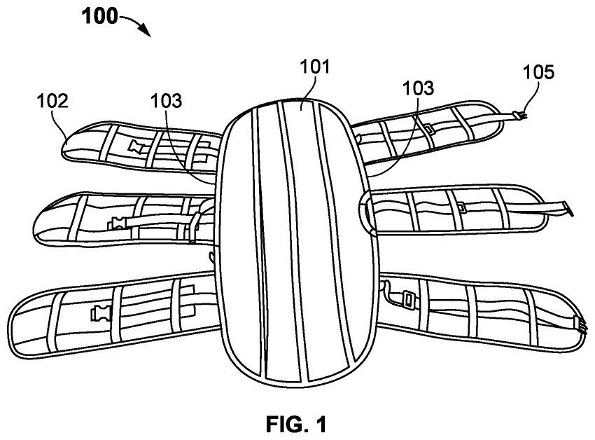

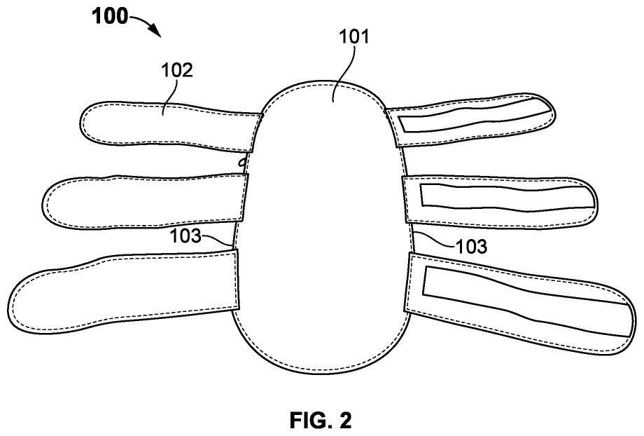

Referring to FIGS. 1-2, a front perspective view and a rear perspective view of a multi-versatile rack 100 for carrying and transporting sports equipment, according to an embodiment of the present invention. The multi-versatile rack 100 is an innovative and intelligent product that has been designed to securely carry and transport sports equipment. In one embodiment, the multi-versatile rack 100 comprises a flat body portion 101 and one or more straps 102. The one or more straps 102 may be at least three pairs of straps. The straps 102 are extending along the length of the flat body portion 101 on its side edges 103. The multi-versatile rack 100 has one or more fasteners 105 at the ends of the straps 102. In one embodiment, each pair of straps 102 includes a fastener 105 at their distal ends configured to lock with each other. In one embodiment, the fasteners 105 may be buckles and Velcro® or hook and loop (H&L) fasteners.

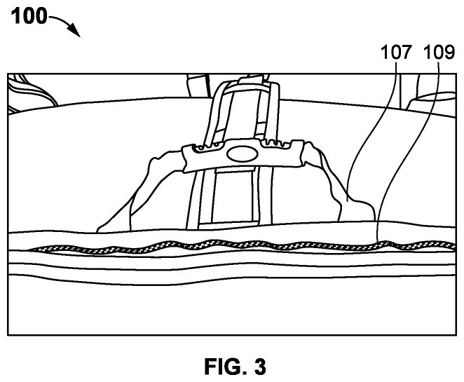

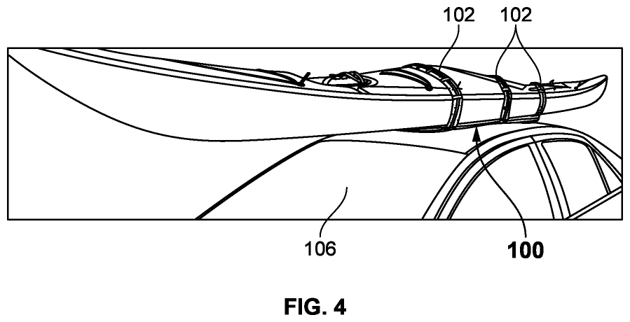

Referring to FIG. 3, an enlarged view of the multi-versatile rack 100, according to one embodiment of the present invention. In one embodiment, the multi-versatile rack 100 comprises a flat body portion 101 and one or more straps 102. The one or more straps 102 may be at least three pairs of straps. The straps 102 are extending along the length of the flat body portion 101 on its side edges 103. In one embodiment, the multi-versatile rack 100 further comprises a pair of handles 107. The handles 107 are sewed to the outer periphery of the flat body portion 101. The handle 107 allows the user to simply carry the sports equipment, for example, a kayak 104 (as shown in FIG. 4). In one embodiment, the multi-versatile rack 100 further comprises a built in compartment with a zipper 109 to convert as a tote bag.

Referring to FIG. 4, a multi-versatile rack 100 may be used for carrying and transporting sports equipment, for example, a kayak 104 on a vehicle 106 in one embodiment of the present invention is disclosed. In one embodiment, the multi-versatile rack 100 is configured to securely carry and transport sports equipment, for example, a kayak 104 on a vehicle 106 roof. In one embodiment, the multi-versatile rack 100 comprises one or more straps 102. The multi-versatile rack 100 is secured to the kayak 104 by extending the straps 102 over the kayak 104 and joining by using one or more fasteners 105, for example, buckles and Velcro® or hook and loop (H&L) fasteners. In one embodiment, the multi-versatile rack 100 may be used for carrying and transporting other objects and sports equipment by securing to the vehicle roof.

In one embodiment, the multi-versatile rack 100 may be a multi-versatile car rack. In one embodiment, the multi-versatile rack 100 may protect more of the vehicle roof and equipment, or anything that transport on the vehicle roof. In one embodiment, the multi-versatile rack 100 may also be used as a board stacker, a sling, a board sleeve, a changing mat, a beach mat, a seat cover and a tote bag, a slide mat, and a cockpit cover. In addition, the user may use two features at the same time and has a built in compartment with a zipper 109 to convert as a tote bag.

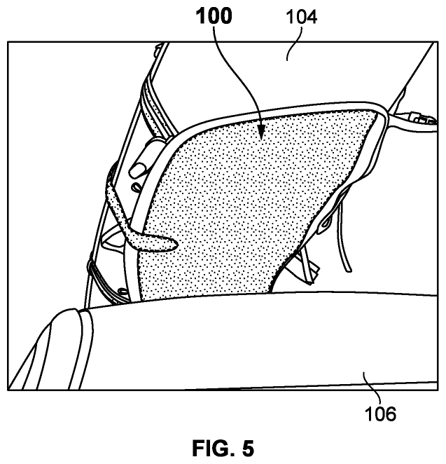

Referring to FIG. 5, the multi-versatile rack 100 may be used as a slide mat for the kayak 104 in one embodiment of the present invention is disclosed. In one embodiment, the multi-versatile rack 100 may be used as a sliding mat for the kayak 104. In one embodiment, the multi-versatile rack 100 allows the kayak to slide easily over its surface. The multi-versatile rack 100 may also be used for sliding onto the vehicle 106 from the rear side, without scratching the paint finish or otherwise damage the vehicle roof.

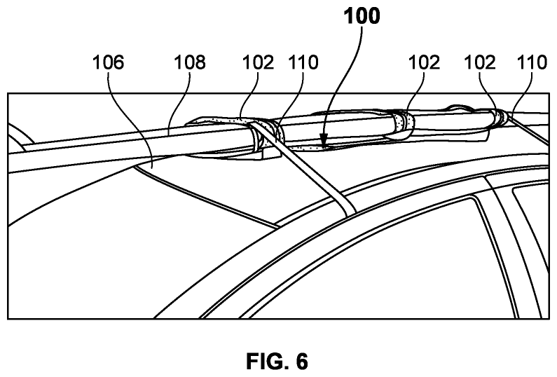

Referring to FIG. 6, the multi-versatile rack 100 may be used for carrying and transporting a surfboard 108 on the vehicle 106 in one embodiment of the present invention is disclosed. In one embodiment, the multi-versatile rack 100 is further configured to securely carry and transport the surfboard 108 on the vehicle 106 roof. The multi-versatile rack 100 is secured to the surfboard 108 by extending the straps 102 over the surfboard 108 and joining by using one or more fasteners 105, for example, buckles and Velcro® or hook and loop (H&L) fasteners. In one embodiment, the multi-versatile rack 100 may be provided with additional straps 110, which are configured to securely hold the surfboard 108 against the roof of the vehicle 106 when the additional straps 110 are tightened. In one embodiment, the additional straps 110 may be, but not limited to, tie down straps.

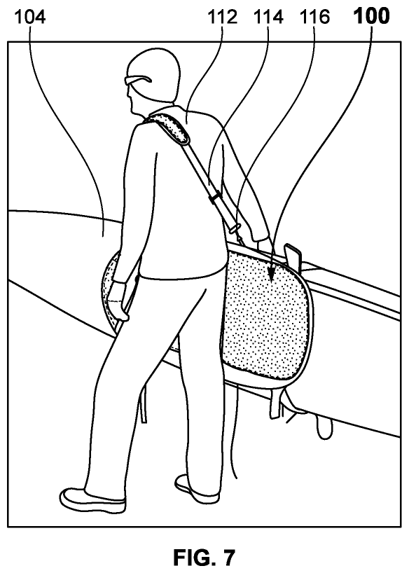

Referring to FIG. 7, the multi-versatile rack 100 may be used as a sling for carrying the kayak 104 by a user 112 in one embodiment of the present invention is disclosed. In one embodiment, the multi-versatile rack 100 is further configured to use as a sling for simply carrying the kayak 104 by the user 112. In one embodiment, the multi-versatile rack 100 may be provided with an additional strap 114. In one embodiment, the additional strap 114 is adjustably secured or affixed to at least any one side portion of the multi-versatile rack 100 via fasteners 116, for example, buckles or hooks, etc. The user 112 could wear the strap 114 over the shoulder, thereby enabling the user 112 to simply carry the kayak 104 using the multi-versatile rack 100 as a sling.

In one embodiment, the additional strap 114 may also include at least one length adjusting element so that the length of the strap 114 is adjusted by the users. In one embodiment, the additional strap 114 may be an elongated adjustable strap. In some embodiments, the additional strap 114 may be, but not limited to, a shoulder strap. In one embodiment, the kayak 104 may be, but not limited to, w-kayak.

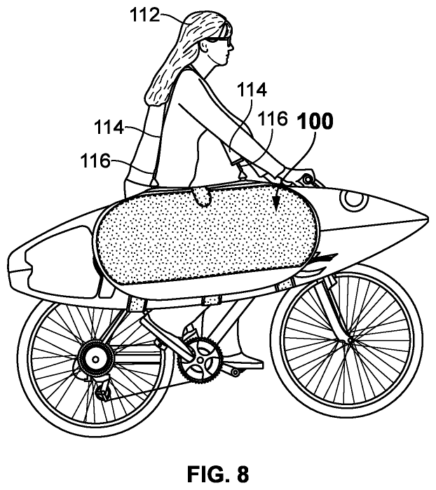

Referring to FIG. 8, the multi-versatile rack 100 may be used as a sling for carrying the surfboard 108 by the user 112 in one embodiment of the present invention is disclosed. In one embodiment, the multi-versatile rack 100 is further configured to use as a sling for simply carrying the surfboard 108. The user 112 could wear the strap 114 over the shoulder, thereby enabling the user 112 to simply carry the surfboard 108 using the multi-versatile rack 100 as a sling.

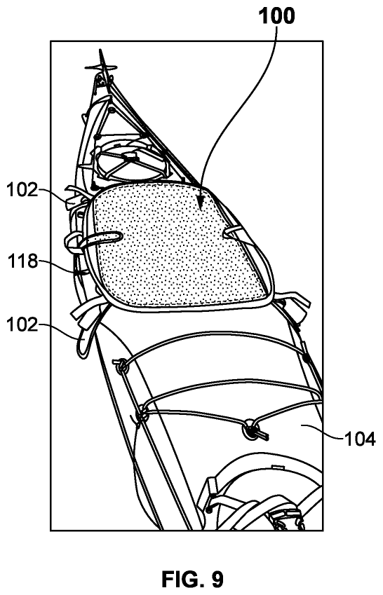

Referring to FIG. 9, the multi-versatile rack 100 may be used as a cockpit cover for the kayak 104 in one embodiment of the present invention is disclosed. In one embodiment, the multi-versatile rack 100 is further configured to be used as a cockpit cover for covering the cockpit opening or seat opening 118 of the kayak 104. The multi-versatile rack 100 is properly secured to the perimeter of the cockpit opening or seat opening 118 using the straps 102. In one embodiment, the multi-versatile rack 100 is fully covered the cockpit opening or seat opening 118 of the kayak 104 to protect while in storage or when being transported.

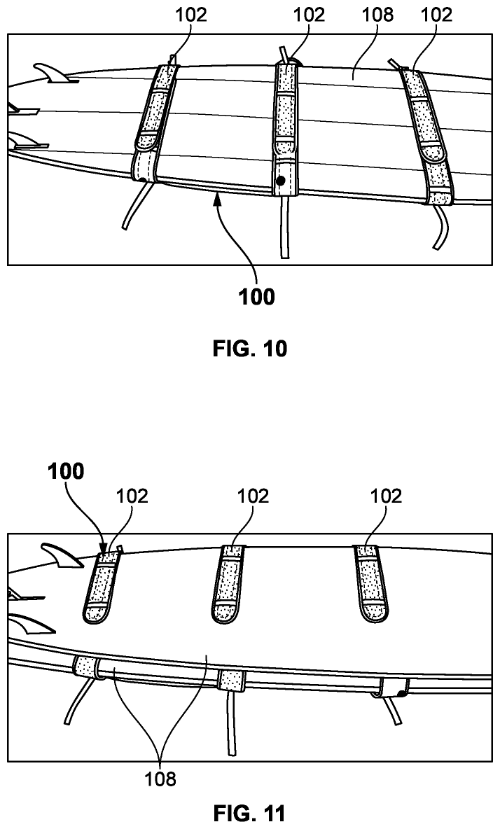

Referring to FIG. 10, the multi-versatile rack 100 may be used for stacking at least one surfboard 108 by the user according to the present invention. In one embodiment, the multi-versatile rack 100 is configured to allow the user to stack at least one surfboard 108 during the transport. In one embodiment, the multi-versatile rack 100 is secured to the surfboard 108 using the straps 102. In one embodiment, the straps 102 are secured or joined using one or more fasteners 105, for example, buckles and Velcro® or hook and loop (H&L) fasteners.

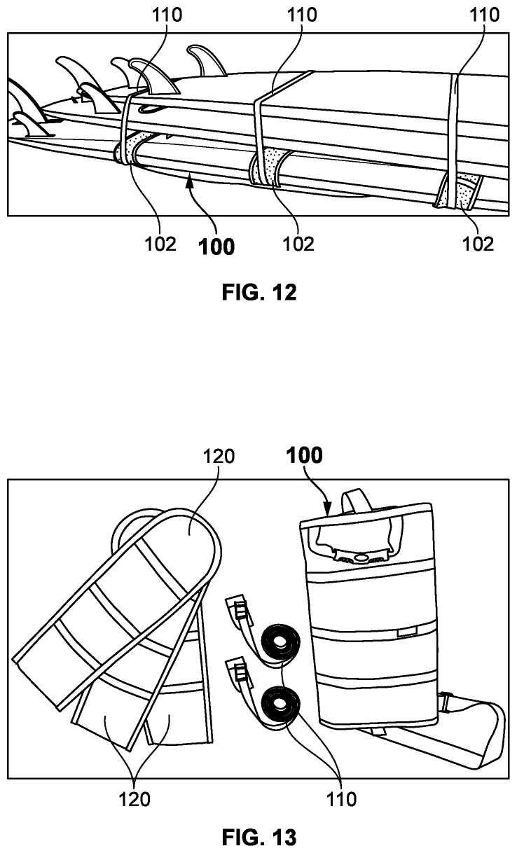

Referring to FIGS. 11-12, the multi-versatile rack 100 may be used for stacking at least two or more surfboards 108 by the user according to the present invention. In one embodiment, the multi-versatile rack 100 is configured to allow the user to stack one or more surfboards on top of each other during the transport of the surfboards 108. The user could be safely secured the surfboards 108 using one or more additional straps 110 without causing any damages and scratches to the surfboards 108.

Referring to FIG. 13, a perspective view of the multi-versatile rack 100 rolled up via a simple folding arrangement in one embodiment is disclosed. In one embodiment, the multi-versatile rack 100 is configured to enable the user to be rolled up and then simply stored away when no longer in use via a simple folding arrangement. In one embodiment, the multi-versatile rack 100 may be provided with extra padded straps 120 for additional padding or length. In one embodiment, the additional straps or tie down straps 110 are used for securely holding the sports equipment, for example, sleds, skis, canoes, kayaks, and surfboards, etc. on the vehicle roof during transporting the sports equipment. In one embodiment, the additional straps or tie down straps 110 may also be used for safely stacking at least two or more surfboards 108. In one embodiment, the additional straps or tie down straps 110 secures around the hood of the vehicle to keep the multi-versatile rack 100 more secure.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1. A multi-versatile device for transporting sports equipment on a vehicle, comprising:
. a rack for supporting the sports equipment on the vehicle;
wherein the rack is formed from flexible material;

2. A multi-versatile device for transporting sports equipment on a vehicle in claim 1, wherein the rack includes at least two straps

3. A multi-versatile device for transporting sports equipment on a vehicle as in claim 2, wherein at least one of the two straps includes a fastener to secure the sports equipment on the vehicle.

4. A multi-versatile device for transporting sports equipment on a vehicle as in claim 3, wherein the fastener includes a buckle.

5. A multi-versatile device for transporting sports equipment on a vehicle as in claim 3, wherein the fastener includes a hook and loop fastener

4. A multi-versatile device for transporting sports equipment on a vehicle as in claim 1, wherein the device is configured for sliding onto the vehicle from the rear side of the vehicle.

6. A multi-versatile device for transporting sports equipment on a vehicle as in claim 1, wherein the rack includes a central aperture to accept padding material.

7. A multi-versatile device for transporting sports equipment on a vehicle as in claim 1, wherein the at least two straps are connected to a side surface of the rack.

8. A multi-versatile device for transporting sports equipment on a vehicle as in claim 2, wherein the at least two straps includes a length adjusting device to adjust the length of the at least two straps.

9. A multi-versatile device for transporting sports equipment on a vehicle as in claim 1, wherein the sports equipment is configured as a board stacker.

10. A multi-versatile device for transporting sports equipment on a vehicle as in claim 1, wherein the sports equipment is configured as sling,

11. A multi-versatile device for transporting sports equipment on a vehicle as in claim 1, wherein the sports equipment is configured as a board sleeve.

12. A multi-versatile device for transporting sports equipment on a vehicle as in claim 1, wherein the sports equipment is configured as a changing mat.

13. A multi-versatile device for transporting sports equipment on a vehicle as in claim 1, wherein the sports equipment is configured as a beach mat.

14. A multi-versatile device for transporting sports equipment on a vehicle as in claim 1, wherein the sports equipment is configured as a seat cover.

13. A multi-versatile device for transporting sports equipment on a vehicle as in claim 1, wherein the sports equipment is configured as a tote bag.

14. A multi-versatile device for transporting sports equipment on a vehicle as in claim 1, wherein the sports equipment is configured as a slide mat.

15. A multi-versatile device for transporting sports equipment on a vehicle as in claim 1, wherein the sports equipment is configured as cockpit cover.
